(19) United States
(12) Patent Application Publication
(10) Pub. No.: US 2025/0111429 A1
(43) Pub. Date: Apr. 3, 2025

(54) VIRTUAL SOCIAL BANKING NETWORKS BY PLATFORM UTILIZING GENERATIVE ARTIFICIAL INTELLIGENCE AND BLOCKCHAIN TECHNOLOGY

(71) Applicant: Wellthi Technologies, Inc., Washington, DC (US)

(72) Inventor: Fonta Gilliam, Washington, DC (US)

(73) Assignee: Wellthi Technologies, Inc., Washington, DC (US)

(21) Appl. No.: 18/480,411

(22) Filed: Oct. 3, 2023

(51) Int. Cl. G06Q 40/02

(52) U.S. Cl. CPC G06Q 40/02

(57) ABSTRACT

Provided is a system including a bank core adapter engine configured for (i) retrieving programs related data from bank cores, each core representing one of a plurality of institutions associated with a respective plurality of users and (ii) normalizing the retrieved programs related data. Also included is a ledger manager configured to create a ledger based on the normalized program related data, wherein the ledger enables at least one of the respective plurality of users to view the normalized program related data as a single account.

### FIELD OF TECHNOLOGY

The present disclosure generally relates to executing software instructions to perform financial transactions. More particularly, the present disclosure relates to executing software instructions to normalize data resulting from financial transactions from multiple financial institutions.

### BACKGROUND

Recent trends reveal an increased reliance on the Internet and social media for communication, dissemination of information, shopping, wellness etc. At the same time, there has been an exponential leap in the capabilities, technologies, and availability of the platforms (e.g., mobile phone technology and high-speed Internet, along with the prevalence of mobile applications) that enable this increased reliance on the Internet and social media. As an example, friends are increasingly abandoning physical houses as gathering spots. An increasing number now prefer Facebook, Instagram, tick-tock and others as more convenient forums for expressing a sense of community.

Additionally, social media is also quickly becoming the opportunity of choice of merchants for engaging and interacting with their customers. For many remaining physical retail outlets, Point of sale (POS) terminals have replaced live cashiers. Within the banking industry, for example, bank branches are closing at an alarming rate across the entire banking industry. As a result, the financial industry is accelerating its push towards digital platforms. Within this context, one capability that continues to be needed is the ability for groups of people to be able to extend the sense of community, provided by social media, to planning, conducting, and sharing financial goals and transactions within the financial industry.

### SUMMARY

Given the aforementioned deficiencies, systems and methods are provided that enable one or more users to plan, conduct, and share financial goals and transactions across communities of different users and financial institutions.

In certain circumstances, an embodiment of the disclosure provides a system including a bank core adapter engine configured for (i) retrieving programs related data from bank cores, each core representing one of a plurality of institutions associated with a respective plurality of users and (ii) normalizing the retrieved programs related data. Also included is a ledger manager configured to create a ledger based on the normalized program related data, wherein the ledger enables at least one of the respective plurality of users to view the normalized program related data as a single account.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates an exemplary block diagram of a community financial transactions system architecture in accordance with embodiments of the present disclosure.

FIG. 2 illustrates a more detailed container-level diagram of the bank core adaptor engine depicted in FIG. 1.

FIG. 3 illustrates a more detailed container-level diagram of the community adaptor engine depicted in FIG. 1.

FIG. 4 illustrates an exemplary registration sequence diagram in accordance with one or more embodiments.

FIG. 5 illustrates an exemplary login sequence diagram in accordance with the embodiments.

FIG. 6 illustrates an exemplary account normalization sequence diagram in accordance with the embodiments.

FIG. 7 illustrates an exemplary goal creation sequence diagram in accordance with the embodiments.

FIG. 8 illustrates an exemplary goal share sequence diagram in accordance with the embodiments.

FIG. 9 illustrates an exemplary goal transaction sequence diagram in accordance with the embodiments.

FIG. 10 illustrates an exemplary goal status sequence diagram in accordance with the embodiments.

FIG. 11 illustrates a block diagram of an exemplary computer controller upon which embodiments of the present disclosure may be practiced.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

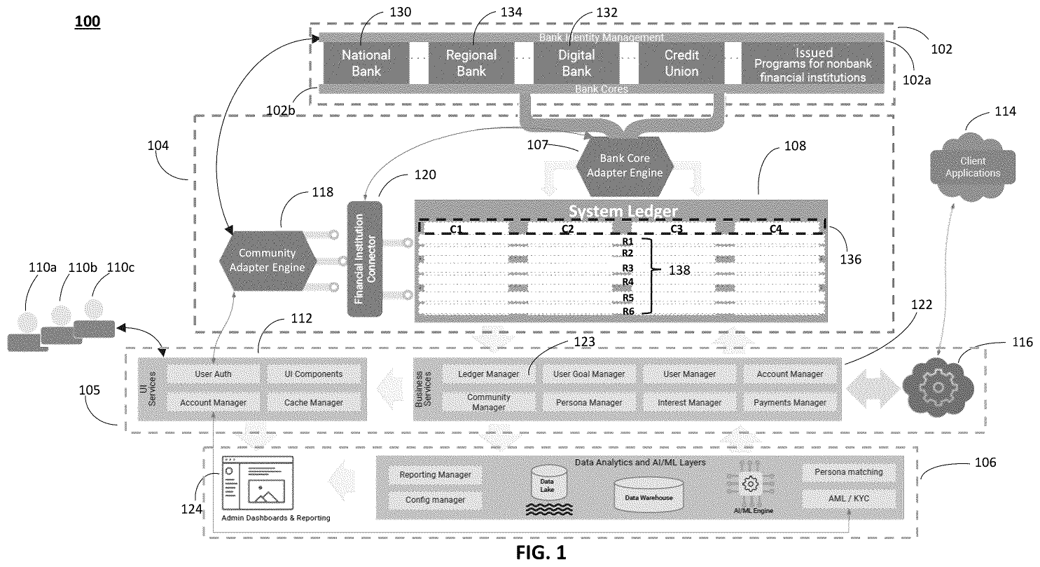

FIG. 1 illustrates an exemplary block diagram of an architecture for a community financial transactions system in accordance with embodiments of the present disclosure. In FIG. 1, a financial transactions normalization system architecture (FTNSA) 100 is depicted as a multi-layered system that serves as an adapter and servicer for transactions occurring across multiple financial institutions and one or more users, simultaneously. By way of example, the FTNSA 100 includes a financial institutions layer 102, an adapter/ledger (i.e., virtual banking community wallet) (VBCW) 104, a services layer 105, and a data analytics and machine learning (ML) layer 106.

The FTNSA 100 can integrate data from multiple financial institutions 102 including, for example, national banks, regional banks, digital credit unions, and the like. Each of the financial institutions 102 includes a bank identity management infrastructure 102a identifying aspects of the user, and bank cores 102b that at our part of the system controlling access to each institution's accounts, transactions etc. Financial transaction programs related data can be taken from the financial institutions 102, more specifically from the bank cores 102b. This data can be adapted to the VBCW 104.

In the embodiments, the VBCW 104 includes a bank core (BC) adapter engine 107 that adapts/normalizes functionality of the bank cores 102b to ultimately create a system ledger 108. In the embodiments, the BC adapter engine 107 is agnostic to the bank cores 102b and may be comprised of a series of computer software routines or microservices. The micro services are executed by a software engine, as described below.

Each computer software routine or microservice, within the BC adapter engine 107, carries a unique responsibility associated with different aspects of at least one corresponding transaction between the multiple financial institutions 102 and the VBCW 104. In the embodiments, the BC adapter engine 107 is configured to normalize program level (e.g., transaction level) data received from any of the financial institutions 102. In the embodiments, by normalizing the transaction level data output from the financial institutions 102, the bank adapter engine 107 converts the transaction data into a single common form, language, or a standard format. The common form, common language, or standard format is sharable between the respective customers of corresponding ones of the financial institutions 102.

As an example, consider a single user having an account in a first one (e.g., National Bank 130) of the four financial institutions 102 desiring to save money jointly with another user (e.g., a partner). In this example, consider the other being a member of a second one of the financial institutions 102 in support of a common savings goal/project.

The system ledger 108 adapts information from the bank core 102b of the financial institutions 102 to enable creation of the common savings goal across the multiple financial institutions 102. The common savings goal may be for the individual benefit of the one user or could be shared with multiple users (e.g., a partner, siblings, friends etc.). In this example, the system ledger 108 a provide an accounting of the savings of the one user across the multiple financial institutions 102 and/or a portion of the savings that may be shared with one or more other users. That is, the system ledger 108 provides a framework from which the accounts and transactions across multiple banks can be viewed as a single account and a single transaction to the one or more users.

For example, a first user 110a may be a system customer of National Bank 130 and a second user 110b may be a customer of Digital Bank 132, both banks within the financial institutions 102. The term system customer refers to a user that may directly access the FTNSA 100 using, for example, through a mobile application through a single sign-on (SSO). Alternatively, a different user may access the FTNSA 100 as a tenant customer (explained in greater detail below). By way of example, a tenant customer may access the FTNSA 100 through their own financial institution using, for example, a federated identity management (FIM) login process.

The first user 110a may access the VBCW 104 (e.g., via a mobile device) through a user interface (UI) module 112. By way of example only, and not limitation, the first user's access may be provided using the SSO process. Once the first user 110a gains access, the VBCW 104 will recognize that the first user 110a is a member of the National Bank 130. As a result, the VBCW 104 will authenticate access by the first user 110a with their account at the National Bank 130 using their National Bank 130 credentials.

Similarly, when the second user 110b accesses the VBCW 104, the VBCW 104 will recognize that the second user 110b is a member of the Digital Bank 132. Accordingly, the VBCW 104 will authenticate the second user 110b's access to their account at the Digital Bank 132 using their Digital Bank 132 credentials.

Alternatively, the users 110a and 110b may access the VBCW 104 through bank client applications 114 associated with respective ones of the financial institutions 102. The client applications 114 may access the system ledger 108 via servers (i.e., clients) that communicate with system application programming interfaces (APIs) and/or software development kits (SDKs) 116. Using this process, the system ledger 108 enables creation of, and communication within, a community of conversation across the multiple financial institutions 102 (e.g., the National Bank 130 and the Digital Bank 132).

The VBCW 104 includes a community adapter engine 118 communicating with one of the financial institutions 102 via a financial institution connector (FIC) module 120. As depicted in FIG. 1, the FIC module 120 communicates with the financial institutions 102 via the bank core adapter 107. In the embodiments, the community adapter engine 118 recognizes that the conversations involving the user 110a, associated with the National Bank 130, and the conversations involving the user 110b (associated with the Digital Bank 132) are related to the common savings goal/project.

In this manner, the community adapter engine 118 identifies institutional and/or social communities associated with each user, formed within their corresponding financial institution. Similarly, the community adapter engine 118 identifies system community groups, responsive to the user's interests and usage. The community adapter engine 118 aggregates the identified institutional, social communities with the identified system groups to facilitate mapping of shared community and savings goals across the financial institutions 102.

In one exemplary embodiment, the community adapter engine 118 monitors conversations across different communities within the system ledger 108 to facilitate the shared savings goals. The community adapter engine 118 will track and join these conversations or communities together.

Within the FTNSA 100, the services layer 105 allows users to connect credit cards and other financial services vehicles to the VBCW 104. Since the VBCW 104 is a wallet, such services are permitted to connect with inputs and outputs of the system ledger 108. The services layer 105 includes the UI services module 112 and a business services module 122. As one example, the UI services module 112 may facilitate typical UI support features such as authentication, as well as accounts and cache management services. In the embodiments, for example, the business services module 122 includes a ledger manager 123 that communicates with the system ledger 108. The business services module 122 may include additional features or components, such as community management (since the VBCW 104 is associated with communities—where social meets finance), ledger management, persona management, and payments management, to name a few.

The data analytics and ML layer 106 facilitates aggregation of the data using ML and artificial intelligence (AI) engines to provide data analytics. The data analytics and ML layer 106, creates metrics based on the data analytics, that may be reported back to the users 110a and/or 110b. The data analytics and ML layer 106 also provides anti-money laundering (AML) and know your customer (KYC) functionality for detection and response to nefarious actors through interaction with UI services module 112. Related reports may also be provided to users or customers via administrative dashboards 124.

In yet another example, a user 110c may select Regional Bank 134, from among the institutions 102, as their financial institution. In this example, however, not only is the financial institution (e.g., the Regional Bank 134) of the user 110c is known. A corresponding community associated with the user 110c may also be identified. That is, each of the financial institutions 102 brings along its own corresponding community that will be managed within the system ledger 108. Within the system ledger 108, data structures are provided to facilitate assignment of storage locations, such as columns (e.g., C1-C4) 136, to a corresponding one of the financial institutions 102.

In the embodiments, within each of the columns 136, corresponding rows (e.g., R1-R6) 138, associated with each of the columns 136, may represent different communities, or groups of users, interacting with each of the institutions 102. In the example above, column C1 may represent the Regional Bank 134. Within the column C1, row R1 may represent a community of one or more users associated with a savings goal ledger or objective, while row R2 may represent a different community of one or more users associated with a non-profit funding ledger.

In the embodiments, the community may include family, friends, and partners centered around a specific financial goal. The community may also comprise one or more public groups moderated, as an example, by a third-party intermediary.

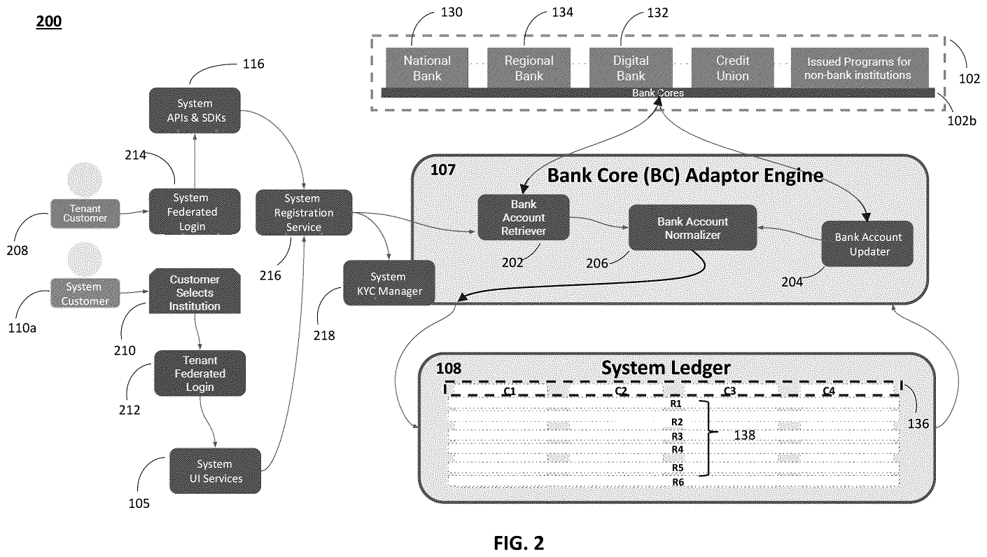

FIG. 2 illustrates a more detailed container-level diagram of a system 200 including the bank core adaptor engine 107 depicted in FIG. 1. In FIG. 2, for example, the BC adapter engine 107 includes a bank account retriever module 202 that receives account reference data from a customer's bank core 102b that corresponds to the customer's financial institution 102. A bank account updater module 204 keeps account data associated with the financial institutions 102, updated. The updates occur through event notifications or batch jobs dependent on capabilities of individual ones of the bank cores 102b.

A bank account normalizer module 206 receives account reference data output from the bank account retriever module 202 and normalizes the received account reference data. Similarly, the bank account normalizer 206 receives updated bank account transaction data, output from the bank account updater 204, and normalizes the updated transactions data. The normalized account reference data and the normalized updated bank account transaction data are used to build and support the system ledger 108.

In the embodiments, the system ledger 108 facilitates managing and tracking customer savings goals across the multiple financial institutions 102 and goals allowing customers to save together even if they bank at different financial institutions. The BC adapter engine 107 and the system ledger 108 map savings goals to the user's accounts and keeps track of the money movement in and out of the savings goal allowing the BC adapter engine 107 and the system ledger 108 leverage For Benefit Of (FBO) accounts from partner Banks and agent banks. Collectively, the BC adapter engine 107 and the system ledger 108 map customer's savings goals across different financial institutions to create and manage shared goals together.

The exemplary embodiment of FIG. 2 may create a community comprised of at least one tenant customer 208 and a system customer, represented here by the user 110a (discussed above in relation to FIG. 1). The user 110a may access the BC adapter engine 107 by selecting their institution. In the example of FIG. 1, the user 110a had a banking relationship with the National Bank 130. Accordingly, the user 110a may select the National Bank 130 at activity block 210 and authenticates their identity/credentials using a tenant FIM login with the National Bank 130 at activity block 212. The interface between the user 110a and the BC adapter engine 107 is provided via the system UI services 105, depicted in FIG. 1.

At the same time, the tenant customer 208 may access the BC adapter engine 107 by logging in at activity block 214 and authenticating identity/credentials using a system FIM login. Authentication/validation ensures the tenant customer 208 and the system customer 110a are authorized to participate. The tenant customer 208 interfaces with the BC adapter engine 107 through the system APIs/SDKs 116. After validation, the system customer (i.e., user 110a) and the tenant customer 208 may now register for service with the BC adapter engine 107 via system registration service activity block 216.

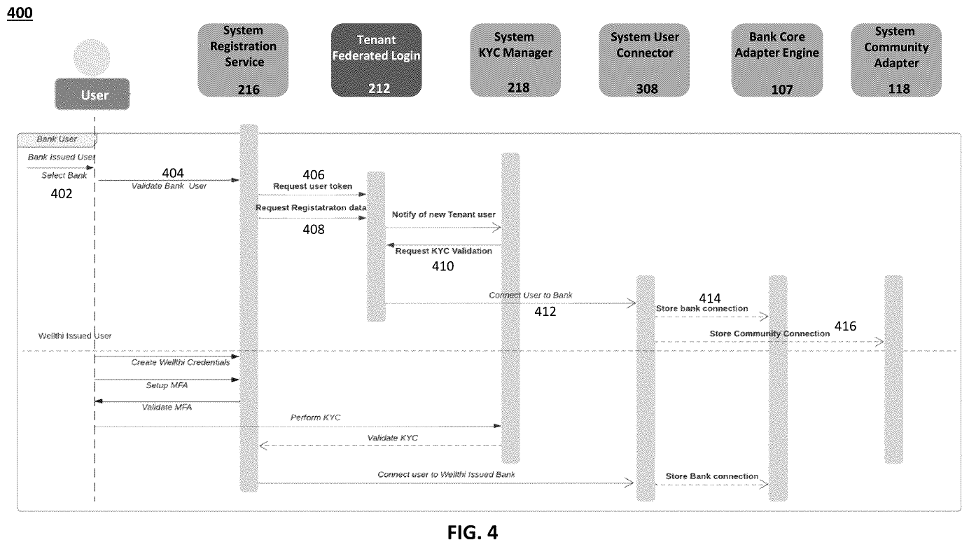

During registration (depicted in greater detail below with reference to FIG. 4), a system KYC manager 218 obtains and verifies customer KYC data from their respective financial institutions. Subsequent to the KYC verification, connection data from the tenant customer 208 and the system customer 110a is stored, along with data representative of their community association(s). The Corresponding account reference data may now be retrieved via the bank account retriever module 202, in the manner discussed above.

Within the example of FIG. 2, the columns 136 (C1-C4) may represent corresponding bank FBO ledgers. Within each of the columns 136, rows R1/R2 may continue to represent a community of one or more users associated with a savings goal ledger or objective, while row R2 may represent a different community of one or more users associated with a non-profit funding ledger within the bank FBO ledgers.

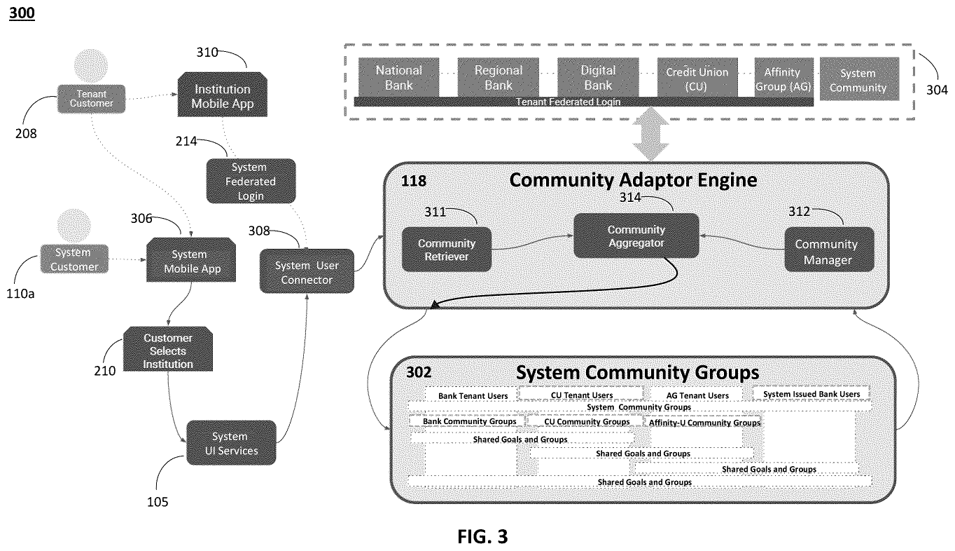

FIG. 3 illustrates a more detailed container-level diagram of a system 300 providing the community adaptor engine 118 depicted in FIG. 1. In particular, FIG. 3 provides a more details about the role community adapter engine 118 performs in creating community groups. For example, the community adapter engine 118 interacts with system community groups 302 and potential customer community members 304 to create the community groups discussed below and above.

In an example scenario, the system customer 110a may sign in via a mobile application 306. As discussed earlier, the system customer 110a may select their financial institution in the activity block 210 and connect with system user connector 308 through the system UI services block 105. The system user connector 308 provides the customer 110a access to the community adapter engine 118. Similarly, or alternatively, the tenant customer 208 may gain access to the system 300 through the system mobile app 306 or an institution's (e.g., their financial institution) mobile app 310. Once the mobile app process has completed, the tenant customer 208 may perform a system FIM login at the activity block 214 to authenticate their identity and/or credentials.

The exemplary system 300 of FIG. 3 uses open standards, including security assertion markup language (SAML), open authorization OAuth), and OpenID Connect (OIDC) to interface with its tenant's authorization systems. Other standards are known to those of skill in the art and would be within the spirit and scope of the present disclosure. Upon authentication, the tenant customer 208 may connect with the system user connector 312 for access to the community adapter engine 118.

In the embodiments, the community adapter engine 118 includes a community retriever module 310 that identifies the institutional community for the specified customer (e.g., the system customer 110a and/or the tenant customer 208). The community manager module 312 identifies relevant system community groups based on the interests and usage of the customers. A community aggregator module 314 aggregates the institutional community data output from the community retriever 310 with the relevant system community groups identification data output from the community manager 312 to create the system community groups 302.

The system community groups 302 contain a mapping of the community groups and shared community goals reflected across the different tenant institutions. This mapping allows customers to engage, share and save across different financial and non-financial institutions. In the exemplary embodiments, the community adapter engine 118 and the BC adapter engine 107 manage the conversations across the various communities to facilitate the shared savings goals.

By way of example only, and not limitation, the system community groups 302 of FIG. 3 depicts bank, affinity group, and credit union communities around the shared savings goals. There are also system community groups that every system customer, such as the customer 110a, can participate in.

FIGS. 4-10 illustrate sequence diagrams, most of which depict actions or processes discussed above in relation to FIGS. 1-3. Therefore, only highlights of selected ones of FIGS. 4-10 will be discussed or repeated in the text below.

FIG. 4 illustrates an exemplary diagram of a registration sequence 400 in accordance with one or more exemplary embodiments. Many of the actions within the sequence 400 were previously described and will not be repeated here. In an example scenario, when a user registers, using the sequence hundred, the user selects a bank at action 402 and the bank user is validated at action 404 using the system registration service 216 discussed in relation to FIG. 2. A user token and registration data are requested at actions 406 and 408 by the tenant federated login activity block 212. Notification of the new (tenant) user is provided to the system KYC manager 218, after which, system KYC manager 218 in-turn requests the user's KYC at activity 410. Once the KYC validation is completed, the user is connected to the bank at activity 414. The user connection is stored at activity 416, along with the recognition user is part of their bank's community.

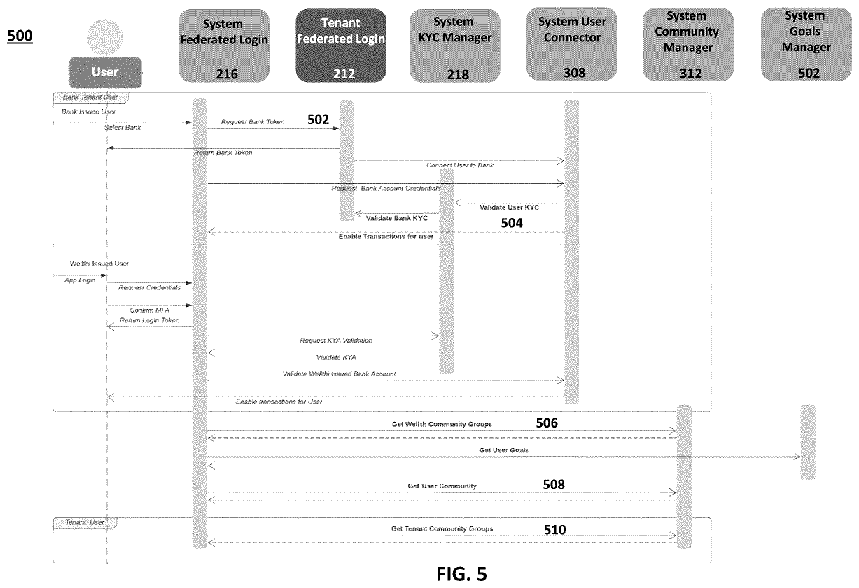

FIG. 5 illustrates a diagram of an exemplary login sequence 500 in accordance with the embodiments. As depicted in FIG. 5, login sequence 500 processes a login request from a bank tenant user at block 502. The login sequence 500 validates the user's bank credentials ensure user is authorized to connect to the bank. The login sequence 500 also establishes the communities, discussed herein, at block 506, 508, and 510. By way of example, the user obtains a system community group, in addition to obtaining their own community. A tenant community group is also provided.

In the example of FIG. 5, login sequence 500 includes execution of one or more software requests using the system federated login module 216, the tenant federated login module 212, system KYC manager 218, system user connector 308, the system community manager 312, and the system goals manager 502 to grant the access requested by the user.

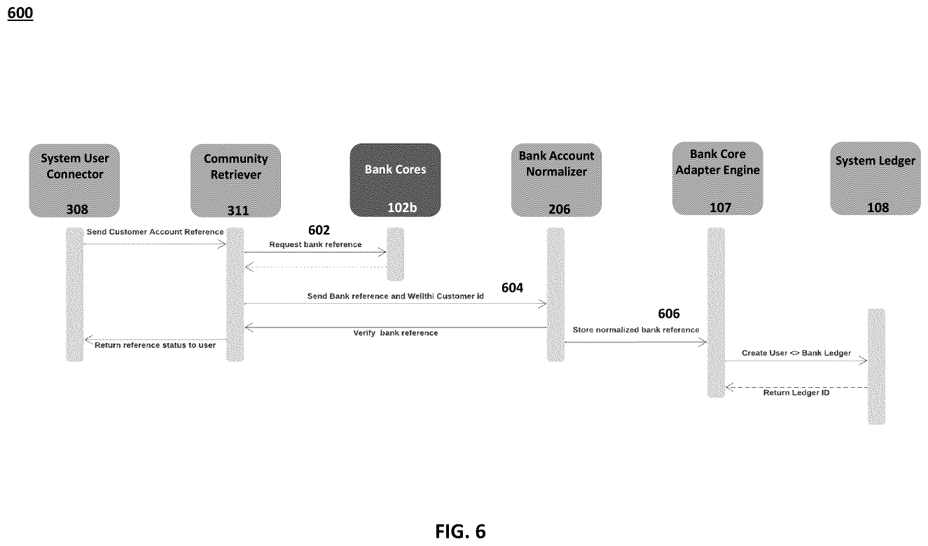

FIG. 6 illustrates a diagram of an exemplary normalization sequence 600 in accordance with the embodiments. In particular, the normalization sequence 600 of FIG. 6 illustrates how reference identifications (IDs) are mapped. For example, the system requests and obtains the bank reference at block 602 through the bank cores 102b. It maps it to a system customer ID and normalizes the bank reference in block 606 at block 604 via the bank account normalizer 206. The normalized bank reference is then stored in the system ledger 108 using the bank core engine 107.

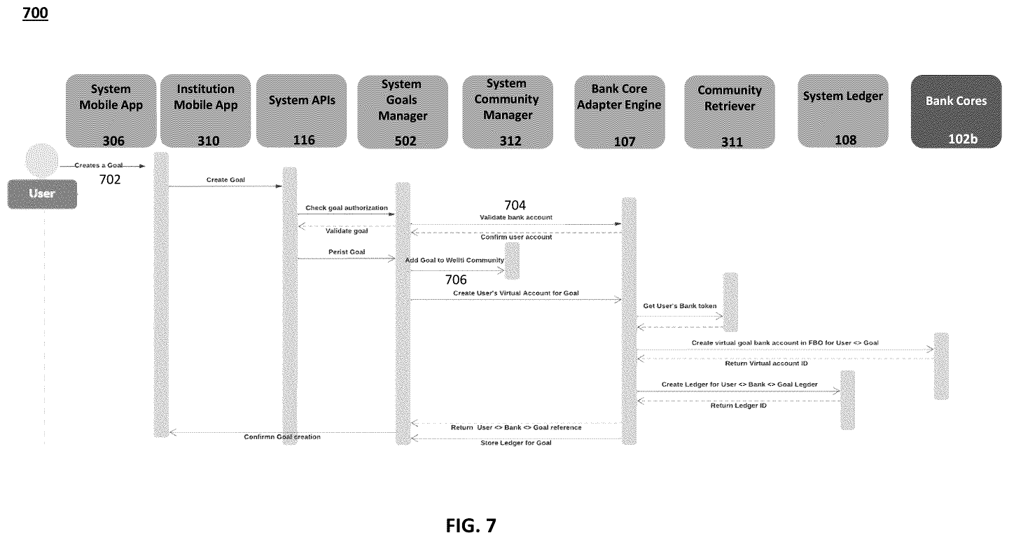

FIG. 7 illustrates an exemplary diagram of a goal creation sequence 700 in accordance with the embodiments. In the sequence 700, the user creates a goal at block 702. The account information is validated at block 704. The created goal is added to the system community at block 706, via the system community manager 312. Of note, in this instance, is that in the present disclosure, a goal is not just a transaction, but it is also the social aspect of the goal (i.e., sharing the goal with the community, and/or sharing the goal with friends and family.

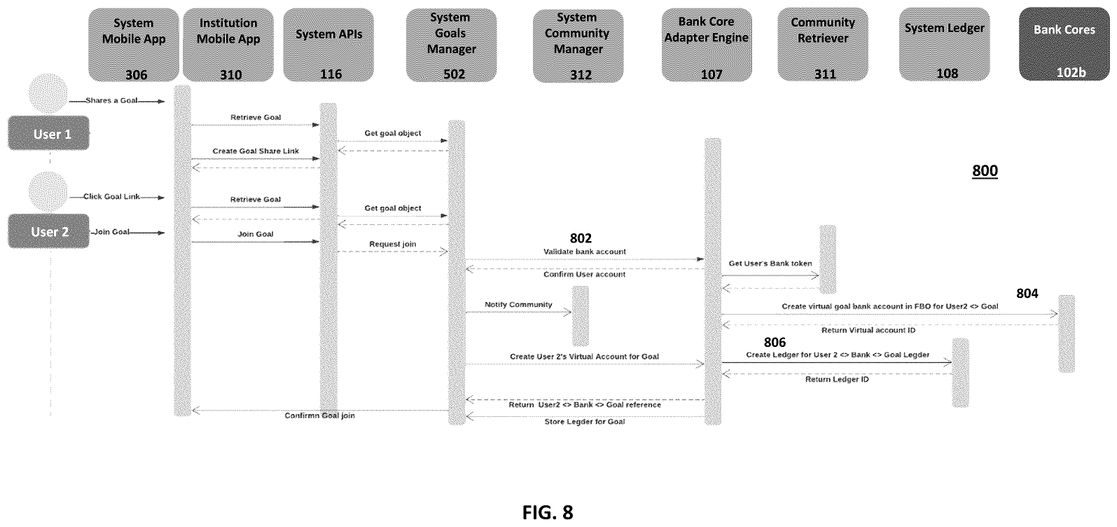

FIG. 8 illustrates an exemplary diagram of a goal sharing sequence 800 in accordance with the embodiments. The goal sharing sequence 800 may be particularly helpful where user—has an account at Bank-X, along with the corresponding community. Here, the bank core adapter engine 107 communicates with the ledger manager 123 to create the system ledger 108. The bank core adapter engine may also create a virtual goal bank account (FBO) for user-1 (see FIG. 7).

In this example, if a friend (e.g., user-2) of user-1 has an account at Bank-Y where user-1 and user-2 desire to save together (e.g., in support of a joint vacation). User-2's Bank-Y account is validated at block 802 and it is confirmed that user-2 participates in a Bank-Y community program. Upon confirmation a virtual goal bank account (FBO) is created for the user-2 at their own bank (i.e., Bank-Y). A system ledger is also created at block 806 to facilitate combining the goals and the savings. Thus, user-1's virtual account at bank-X and user-2's account at bank-Y may be combined into one ledger (i.e., viewed as a single account).

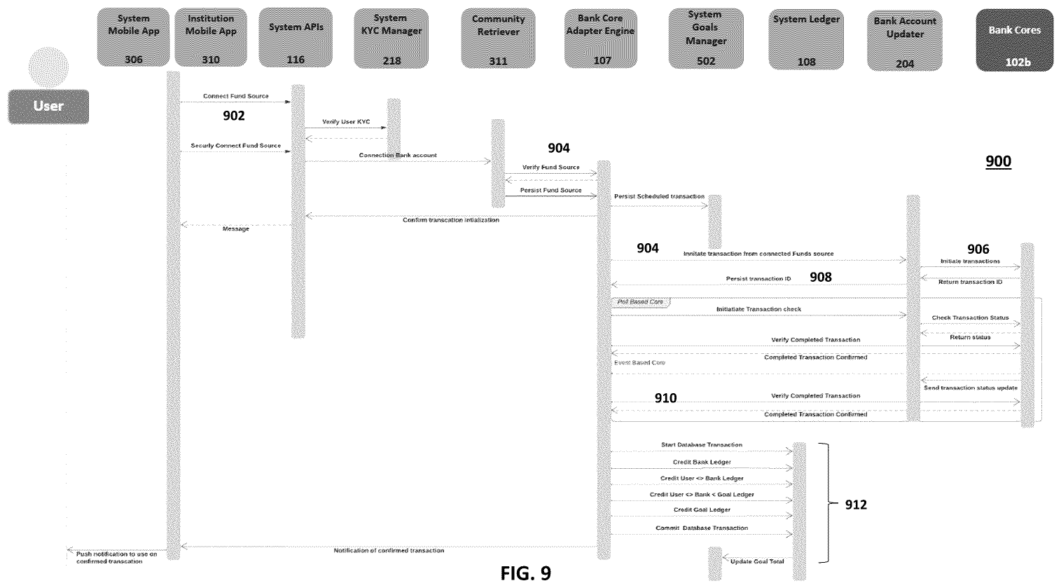

FIG. 9 illustrates a diagram of an exemplary goal transaction sequence 900 in accordance with the embodiments. The goal transaction, for example, could be scheduling funds for movement from the user's bank account to the shared goal, created in the ledger at block 806 in FIG. 8. Here, the user connects to a funding source at block 902 that is verified at block 904. The bank account updater 204 initiates the transaction at block 906, providing a transaction ID at block 908, and completion verification at block 910. Finally, a series of instructions are executed between the bank core engine 107 and the system ledger 108, to update the ledger 108 to reflect an updated goal funding total.

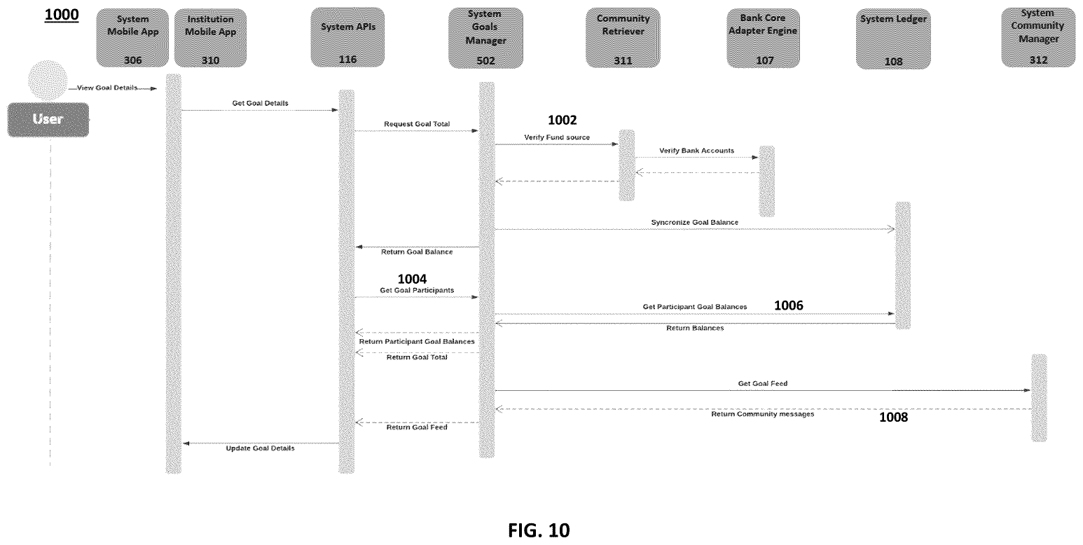

FIG. 10 illustrates an exemplary diagram of a goal status sequence 1000 in accordance with the embodiments. By way of example only, and not limitation, the goal status sequence 1000 may be configured to satisfy a user request for information such as verification funding source at block 1002 verification of goal participants 1004, obtain goal balances 1006, respond to community messages 1008, among other activities.

As used herein, the term engine, in association with the BC adapter engine 107 and the community adapter engine 118, denotes software engines. As understood by those of skill in the art, a software engine is a core component of a complex software system that executes the foundation or crucial task for other programs. In the embodiments, the software engine is executed on a computer controller.

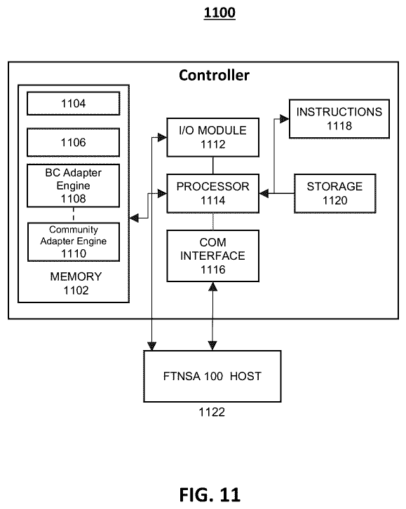

FIG. 11 illustrates a controller 1100 that may be an application-specific hardware, software, and firmware implementation of the sequences of FIGS. 4-10 described above. The controller 1100 can include a processor 1114 configured to be executed one or more, or all of the blocks of the sequences of FIGS. 4-10, or the functions of the exemplary FTNSA 100 described above.

The processor 1114 can have a specific structure imparted to the processor 1114 by instructions stored in a memory 1102 and/or by instructions 1118 fetchable by the processor 1114 from a storage medium 1120. The storage medium 1120 can be remote and communicatively coupled to the controller 1100. Such communications can be encrypted.

The controller 1100 can be a stand-alone programmable system, or a programmable module included in a larger system. For example, the controller 1100 may include or be connected with, the BC adapter engine 107. For example, the controller 1100 may include one or more hardware and/or software components configured to fetch, decode, execute, store, analyze, distribute, evaluate, and/or categorize information.

The processor 1114 may include one or more processing devices or cores (not shown). In some embodiments, the processor 1114 may be a plurality of processors, each having either one or more cores. The processor 1114 can execute instructions fetched from the memory 1102, i.e., from one of memory modules 1104, 1106, 1108, or 1110. Alternatively, the instructions can be fetched from the storage medium 1120, or from a remote device connected to the controller 1100 via a communication interface 1116. Furthermore, the communication interface 1116 can also interface with computer systems within a computer system of the bank core adapter engine 107 or the community adapter engine 118. An I/O module 1112 may be configured for additional communications to or from associated remote systems of a host 1122 of the FTNSA 100.

Without loss of generality, the storage medium 1120 and/or the memory 1102 can include a volatile or non-volatile, magnetic, semiconductor, tape, optical, removable, non-removable, read-only, random-access, or any type of non-transitory computer-readable computer medium. The storage medium 1120 and/or the memory 1102 may include programs and/or other information usable by processor 1114. Furthermore, the storage medium 1120 can be configured to log data processed, recorded, or collected during the operation of controller 1100.

The data may be time-stamped, location-stamped, cataloged, indexed, encrypted, and/or organized in a variety of ways consistent with data storage practice. By way of example, the memory module 1108 can form the previously described bank core adapter engine 107 and the memory module 1110 can form the community adapter engine 118. The instructions embodied in these memory modules can cause the processor 1114 to perform certain operations consistent with the functions described in FIGS. 1-3 and 6 above.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A system comprising:
a bank core adapter engine configured for (i) retrieving programs related data from bank cores, each core representing one of a plurality of institutions associated with a respective plurality of users and (ii) normalizing the retrieved programs related data; and
a ledger manager module configured to create a ledger based on the normalized program related data;
wherein the ledger enables at least one of the respective plurality of users to view the normalized program related data as a single account.

2. The system of claim 1, further comprising a community adapter engine configured to (i) identify communities associated with one or more of the respective plurality of users and (ii) identify community groups based on usage data of the one or more users.

3. The system of claim 2, further comprising aggregating the identified communities and the identified community groups for mapping within the ledger.

4. The system of claim 1, wherein the plurality of institutions include financial institutions and non-financial institutions.

5. The system of claim 1, wherein the programs related data includes at least one of transaction level data and reference level data.

6. The system of claim 5, wherein the bank core adapter further comprises a bank account retriever module configured for obtaining any account reference level data from each of the bank cores; and
a bank account updater for obtaining the transaction level data.

7. The system of claim 6, wherein the bank core adapter further comprises a bank account normalizer configured for normalizing the transactions level data in the reference level data;
wherein the bank core adapter uses the normalized transaction level data and the reference level data to create the ledger.

8. The system of claim 1, wherein each of the plurality of users is associated with an institutional community; and
wherein other members of the institutional community can view the normalized program related data as the single account.

9. A method comprising:
configuring a bank core adapter engine to (i) retrieve programs related data from bank cores, each core representing one of a plurality of institutions associated with a respective plurality of users and (ii) normalize the retrieved programs related data; and
create a ledger, via a ledger manager module, to create a ledger based on the normalized program related data;
wherein the ledger enables at least one of the respective plurality of users to view the normalized program related data as a single account.

10. The method of claim 9, wherein the plurality of institutions include financial institutions and non-financial institutions.

11. The method of claim 10, wherein the programs related data includes at least one of transaction level data and reference level data.

12. The method of claim 11, wherein the bank core adapter further comprises a bank account retriever module configured for obtaining any account reference level data from each of the bank cores; and
a bank account updater for obtaining the transaction level data.

13. The method of claim 12, wherein the bank core adapter further comprises a bank account normalizer configured for normalizing the transactions level data in the reference level data;
wherein the bank core adapter uses the normalized transaction level data and the reference level data to create the ledger.

14. A system comprising:
a bank core adapter engine configured for (i) retrieving programs related data from bank cores, each core representing one of a plurality of institutions associated with a respective plurality of users and (ii) normalizing the retrieved programs related data; and
a ledger manager module configured to create a ledger based on the normalized program related data;
wherein the ledger enables at least one of the respective plurality of users to view the normalized program related data as a single account; and
a community adapter engine configured to (i) identify communities associated with one or more of the respective plurality of users and (ii) identify community groups based on usage data of the one or more users.

15. The system of claim 14, further comprising aggregating the identified communities and the identified community groups for mapping within the ledger.

16. The system of claim 14, wherein the plurality of institutions include financial institutions and non-financial institutions.

17. The system of claim 14, wherein the programs related data includes at least one of transaction level data and reference level data.

18. The system of claim 17, wherein the bank core adapter further comprises a bank account retriever module configured for obtaining any account reference level data from each of the bank cores; and
a bank account updater for obtaining the transaction level data.

19. The system of claim 18, wherein the bank core adapter further comprises a bank account normalizer configured for normalizing the transactions level data in the reference level data;
wherein the bank core adapter uses the normalized transaction level data and the reference level data to create the ledger.
